(19) United States
(12) Patent Application Publication
(10) Pub. No.: US 2016/0310873 A1
(43) Pub. Date: Oct. 27, 2016

(54) QUICK-RELEASE DEVICE AND AN INDUSTRIAL FILTER HAVING THE SAME

(71) Applicant: Kenneth WONG, Zhubei City (TW)

(72) Inventor: Kenneth WONG, Zhubei City (TW)

(21) Appl. No.: 15/135,972

(22) Filed: Apr. 22, 2016

(30) Foreign Application Priority Data
Apr. 24, 2015 (TW) 104206285

(51) Int. Cl. B01D 27/08

(52) U.S. Cl. CPC B01D 27/08

(57) ABSTRACT

A quick-release device of an industrial filter is provided, including: a main body, including a first assembling portion for being non-rotatably engaged with a filter assembly and a second assembling portion for being non-rotatably assembled to an external device; a positioning portion, connected to the first assembling portion, complementary to the first engaging portion in structure. An industrial filter includes the quick-release device and the filter assembly. The filter assembly includes an assembling hole communicating with an interior of the external device. The industrial filter may further include the external device. The external device includes a shell body, the quick-release device is positionably arranged in the shell body, and the filter assembly is assembled in the shell body.

### BACKGROUND OF THE INVENTION

1. Field of the Invention

The present invention relates to a filter, and more particularly to a quick-release device and an industrial filter having the same.

2. Description of the Prior Art

Conventionally, during a process of manufacturing a semiconductor or processing, a slurry fluid or a cutting fluid is used to help improve and elevate the efficiency and yielding rate of processing. For example, during a CMP manufacturing process, the slurry fluid is used to grind a surface of a chip which is has an uneven contour, the slurry fluid used needs to be filtered through an industrial filter to remove impurities so that the slurry fluid can be used again.

However, a common industrial filter needs to be replaced frequently, and there are different types of industrial filters having different functions. Therefore, when replacing the industrial filter, a user needs to consider the compatibility of the industrial filters and a filter machine, and it is inconvenient to choose the industrial filter matching with the filter machine. In addition, the industrial filter is disposable and is unfriendly to the environment. Furthermore, a space of a common semiconductor industry is limited and expensive, but it requires a greater space for the user to replace the industrial filter (the user needs to conduct visual check after replacing the industrial filter), and the cost increases.

The present invention has arisen to mitigate and/or obviate the afore-described disadvantages.

### SUMMARY OF THE INVENTION

The major object of the present invention is to provide a quick-release device and an industrial filter having the same, wherein the quick-release device can be used on different filters. The quick-release device is reusable and has a simple structure, and the quick-release device can be disassembled quickly so that it is more convenient for a user to replace the filters and conduct visual check. In addition, the filter can be assembled to other equipments and be further applied to other devices.

To achieve the above and other objects, a quick-release device of an industrial filter is provided, including: a main body, including a first assembling portion and a second assembling portion, the first assembling portion for being non-rotatably and detachably connected with a filter assembly, the second assembling portion for being non-rotatably and detachably assembled to an external device; and a positioning portion, connected to the first assembling portion, the positioning portion for being engaged with a first engaging portion of the filter assembly, the positioning portion including at least one engaging recess or at least one engaging protrusion, the positioning portion being complementary to the first engaging portion in structure.

To achieve the above and other objects, an industrial filter is provided, including the quick-release device and the filter assembly mentioned above. The filter assembly includes at least one assembling hole communicating with an interior of the filter assembly, and the assembling hole is for being assembled to and communicating with an interior of the external device.

To achieve the above and other objects, an industrial filter is provided, including the quick-release device and the filter assembly mentioned above. The external device includes a shell body, the quick-release device is positionably arranged in the shell body, and the filter assembly is assembled in the shell body.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a sketch of a preferred embodiment of the present invention;

FIG. 2 is a breakdown drawing of the preferred embodiment of the present invention;

FIG. 3 is a drawing showing the preferred embodiment of the present invention in use;

FIG. 4 is another drawing showing the preferred embodiment of the present invention in use;

FIG. 5 is another drawing showing the preferred embodiment of the present invention in use;

FIG. 6 is a cross-sectional view of the preferred embodiment of the present invention;

FIG. 7 is a sketch of another preferred embodiment of the present invention;

FIG. 8 is a breakdown view of another preferred embodiment of the present invention;

FIG. 9 is a cross-sectional view of another preferred embodiment of the present invention;

FIG. 10 is a sketch of still another preferred embodiment of the present invention; and

FIG. 11 is a breakdown view of still another preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

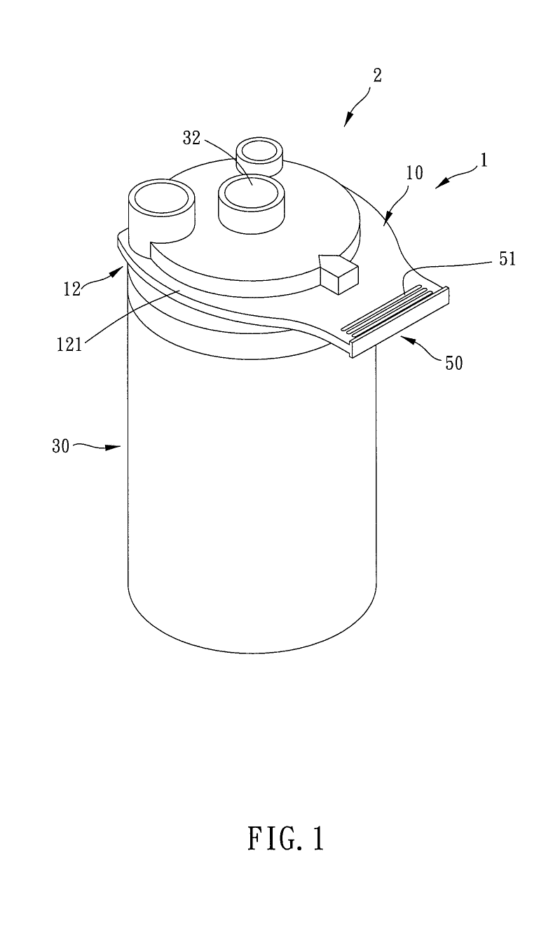

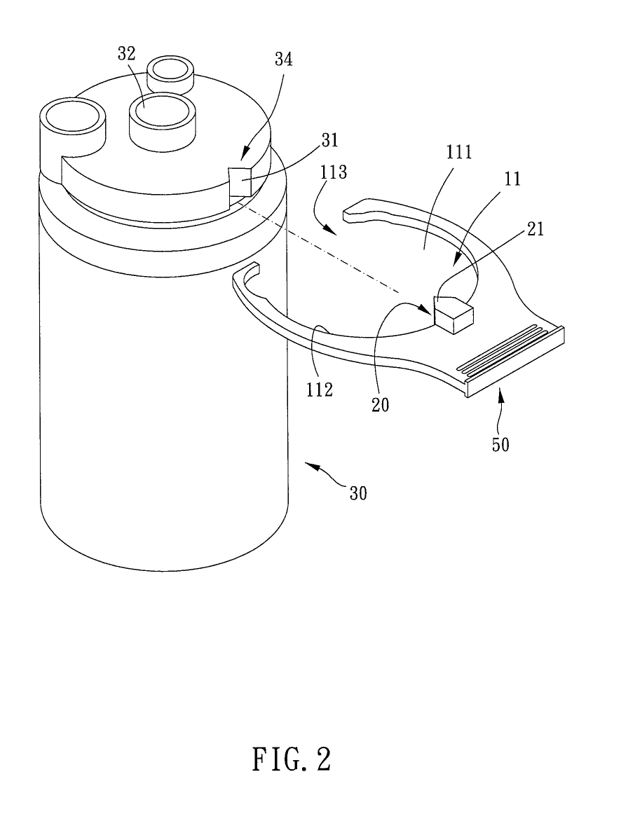

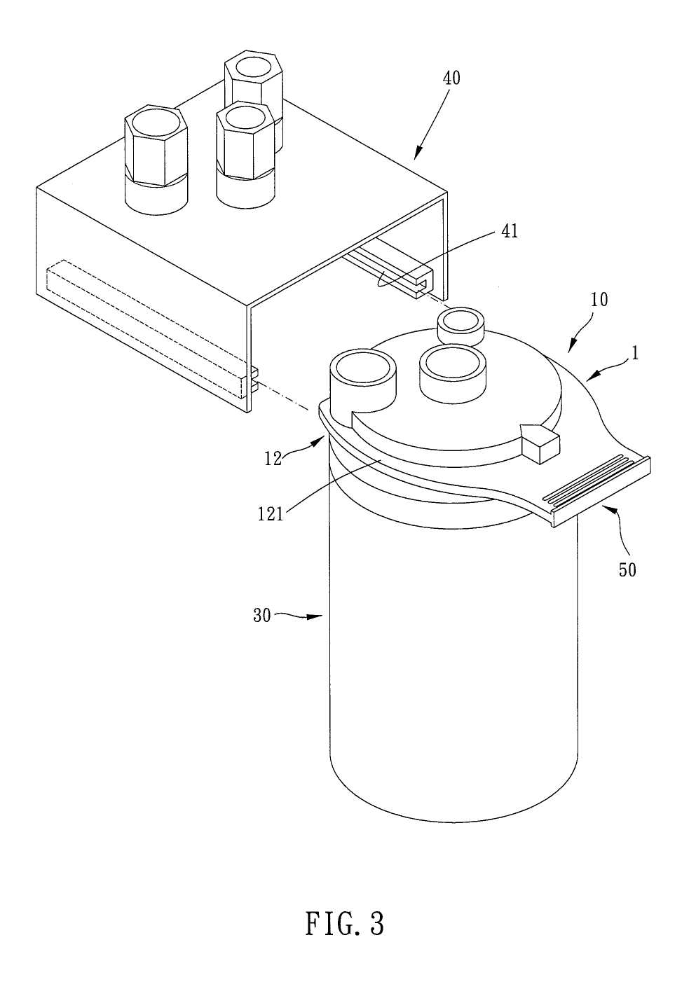

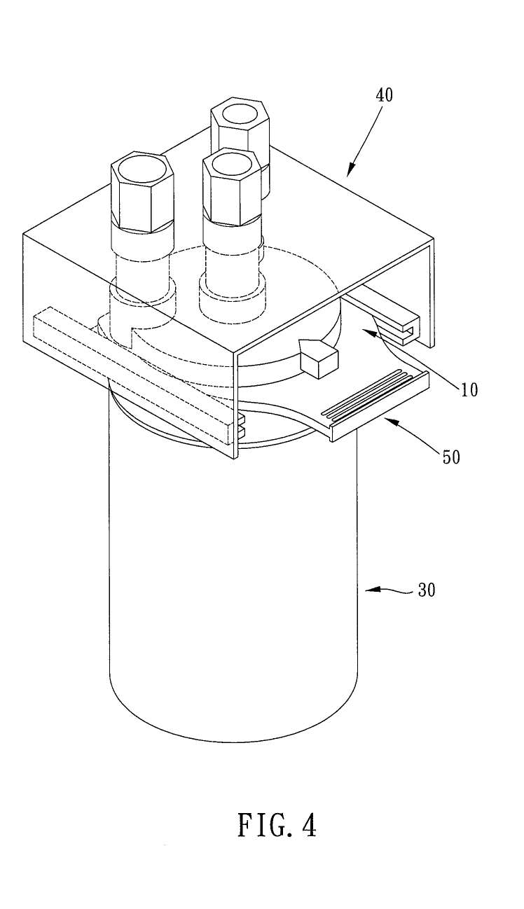

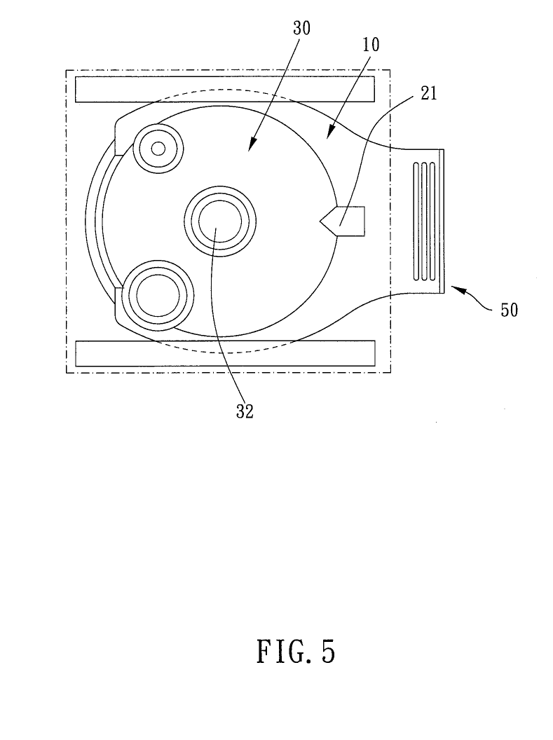

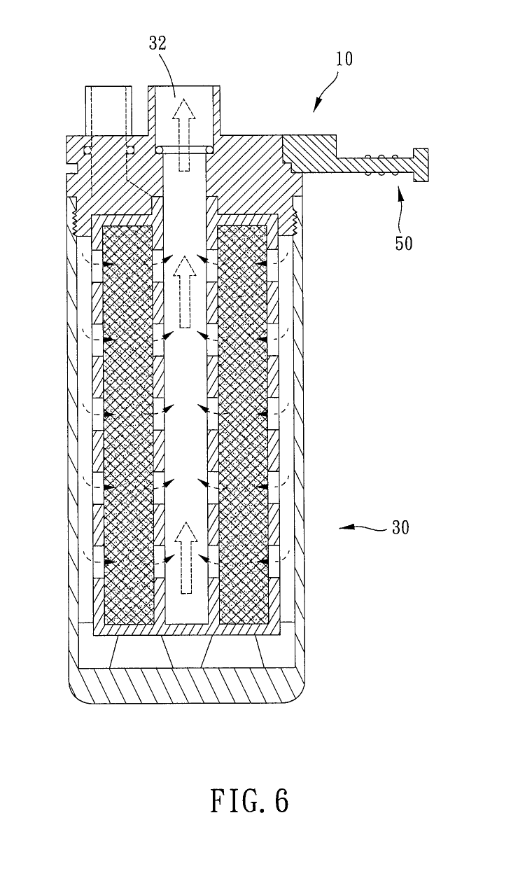

Please refer to FIGS. 1 to 6 for a preferred embodiment of the present invention. A quick-release device 1 of an industrial filter includes a main body 10 and a positioning portion 20.

The main body 10 includes a first assembling portion 11 and a second assembling portion 12, the first assembling portion 11 is for being non-rotatably and detachably connected with a filter assembly 30, and the second assembling portion 12 is for being non-rotatably and detachably assembled to an external device 40. Specifically, for example, the filter assembly 30 may be used to filter a slurry fluid used in a semiconductor industry or a cutting fluid used in a processing process, and the external device 40 may be a connecting portion of a fluid filter machine which has a pressure pump.

In this embodiment, the first assembling portion 11 includes an opening 111 disposed through the main body 10, and the opening 111 is sleeved around the filter assembly 30. Specifically, the opening 111 has a periphery 112, as viewed along a lateral direction of the periphery 112, the periphery 112 is substantially curved, and one side thereof is open to form an open side 113. More specifically, the opening 111 is substantially C-shaped, and the main body 10 is flexible so that the opening 111 can be deformed by a force; and when the force is removed, the opening 111 recovers to an original state, and the main body 10 clamps the filter assembly 30. Preferably, an inner diameter of the opening 111 is slightly smaller than a dimension of a clasping position of the filter assembly 30. The second assembling portion 12 includes two wing portions 121 which are respectively arranged on two opposite external sides of the main body 10 and extend horizontally, each said wing portion 121 extends horizontally outwardly for a predetermined distance, and the predetermined distance may be adjusted according various requirements so as to be engaged with the external device 40.

The positioning portion 20 is connected to the first assembling portion 11, the positioning portion 20 is for being engaged with a first engaging portion 34 of the filter assembly 30, the positioning portion 20 including at least one engaging recess or at least one engaging protrusion, and the positioning portion 20 is complementary to the first engaging portion in structure. Specifically, the filter assembly 30 has the first engaging portion 34 which is complementary to the positioning portion 20 in shape. For example, in this embodiment, the opening 111 has the positioning portion 20 along an inner wall thereof, the positioning portion has at least one protrusive key 21, for example, the inner wall of the opening 111 may have one said protrusive key 21, the first engaging portion 34 of the filter assembly 30 corresponds to the protrusive key 21 and has a recessed portion 31, the protrusive key 21 can be positionably engaged with the recessed portion 31, and when the positioning portion 20 positions the first engaging portion 34, the main body 10 is for being non-rotatable relative to the filter assembly 30.

In actual practice, the main body 10 may further include a holding portion 50, the holding portion 50 extends outwardly, the holding portion 50 is for a hand to hold thereon, and preferably, the holding portion 50 includes a plurality of ribs 51 which are anti-slip. Specifically, the quick-release device 1 may be a plastic member or a metal member integrally formed. More specifically, the quick-release device 1 may be formed through injection molding or impact molding, and the quick-release device 1 has a simple structure so that it is convenient and quick to manufacture the quick-release device 1.

The filter assembly 30 includes at least one assembling hole 32 communicating with an interior of the filter assembly 30, and the quick-release device 1 is disassembly assembled to the filter assembly 30. Specifically, the quick-release device 1 clamps the filter assembly 30 via the opening 111, and the positioning portion 20 and the positioning structure position each other so that the quick-release device 1 and the filter assembly 30 are non-rotatable or non-movable relative to each other. The quick-release device 1 is for being positionably arranged on the external device 40. For example, the external device 40 includes two grooves 41 opposite to each other, the two wing portions 121 of the quick-release device 1 are for being positionably and slidably arranged in the two grooves 41, the quick-release device 1 is positioned in the external device 40, and the filter assembly 30 is positionably assembled to the external device 40. In actual practice, the assembling hole 32 of the filter assembly 30 is for being liquid-sealingly assembled to the external device 40. For example, the assembling hole 32 of the filter assembly 30 includes a liquid inlet hole, a liquid outlet hole and an air passage, and when the assembling holes 32 are for being liquid sealingly assembled to the external device 40, the filter assembly 30 is for the external device 40 to inlet a fluid and filter the fluid.

It is to be noted that the filter assembly 30 is replaceable, and the quick-release device 1 is reusable. For example, when the filter assembly 30 is used for a period of time, the filter assembly 30 can be disassembled from the quick-release device 1, and the other said filter assembly 30 can be assembled to the quick-release device 1 and further assembled to the external device 40 so as to reduce the raw material and environmental burden. The quick-release device 1 is reusable and environment-friendly, the quick-release device 1 is easy to be replaced, and the quick-release device 1 can be applied to various types of filters.

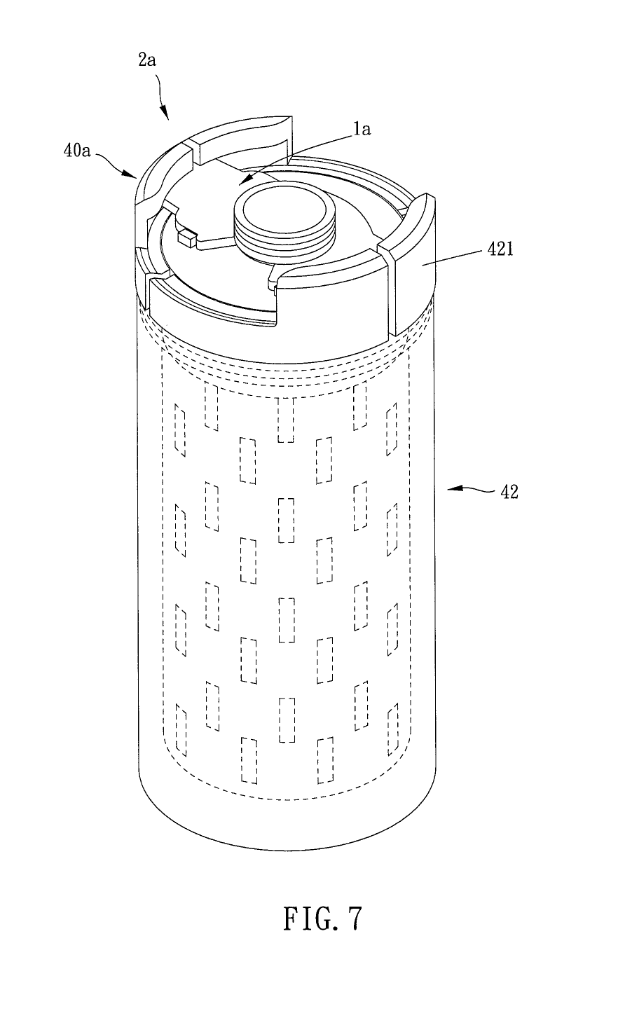

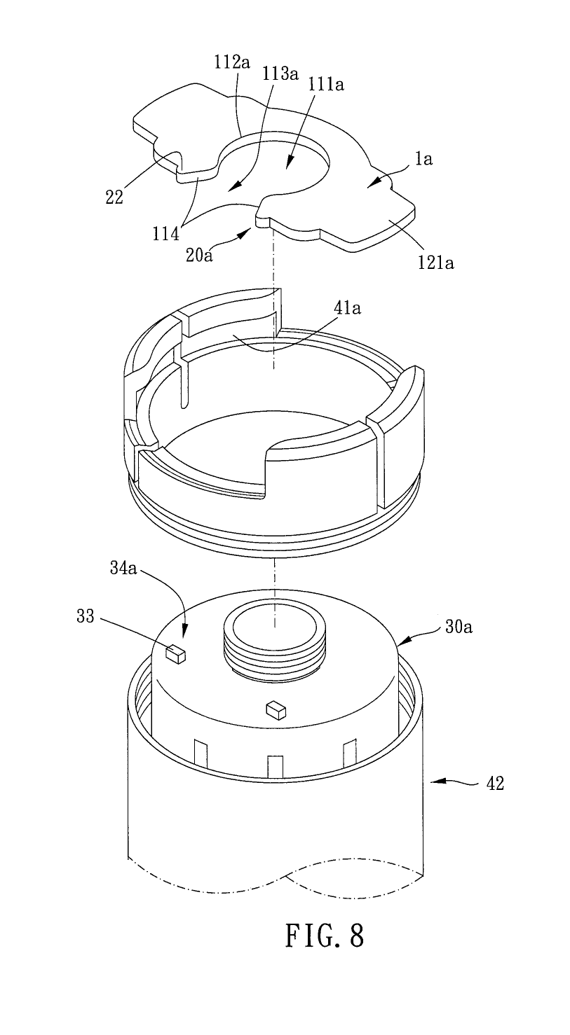

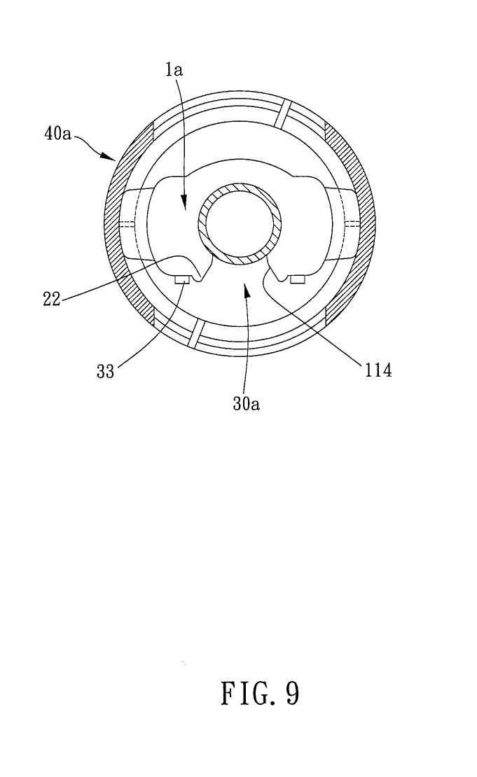

Please refer to FIGS. 7 to 9 for another embodiment, the external device 40a includes a shell body 42, the shell body at least includes an assembling ring 421, an opening 111a of a quick-release device la is substantially Ω-shaped, two opposite sides of an open side 113a of a periphery 112a respectively have a chamfer 114 expanding outwardly, and the chamfer 114 is preferably for guiding and assembling the quick-release device 1a to a filter assembly 30a. A positioning portion 20a is arranged neighboring to the open side 113a, the positioning portion 20a includes two abutting portions 22 which are respectively arranged on two opposite ends of the open side 113a, and a first engaging portion 34a of the filter assembly 30a includes two abutting blocks 33. When the quick-release device 1a is assembled to the filter assembly 30a, the two abutting portions 22 are for abutting against the two abutting blocks 33 respectively, the quick-release device 1a and the filter assembly 30a are non-rotatable relative to each other, and the quick-release device 1a is engaged with a grove 41a of the assembling ring 421 through two wing portions 121a. The quick-release device 1a and the filter assembly 30a are both disassemble, so the filter assembly 30a is replaceable and the quick-release device 1a is reusable.

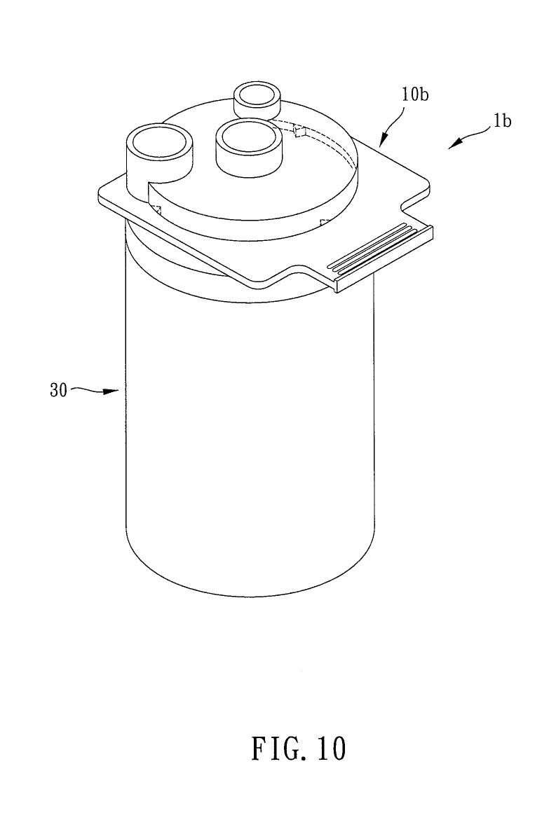

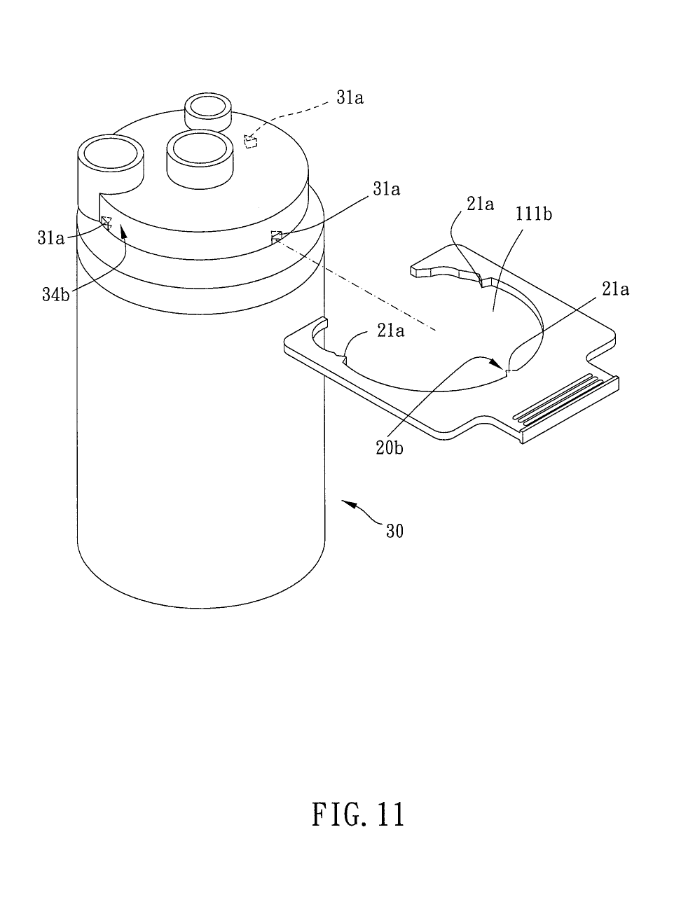

Please refer to FIGS. 10 and 11 for still another embodiment of the present invention. An opening 111b has a positioning portion 20b arranged along an inner wall of the opening 111b, the positioning portion 20b includes three protrusive keys 21a arranged in intervals, the first engaging portion 34b of the filter assembly 30 corresponds to the three protrusive keys 21a and has three recessed portions 31a, the three protrusive keys 21a are positionably engaged with the three recessed portions 31a, and when the positioning portion 20b is positioned in the first engaged portion 34b, a main body 10b of the quick-release device 1b is for being non-rotatable relative to the filter assembly 30.

Please refer to FIGS. 1 to 6 for an industrial filter 2 of the present invention, including the quick-release device 1 mentioned above. The industrial filter 2 includes the filter assembly 30, the filter assembly 30 includes at least one assembling hole 32 communicating with an interior of the filter assembly 30, the quick-release device 1 is disassembly assembled to the filter assembly 30, the quick-release device 1 is for being positionably arranged in the external device 40, the assembling hole 32 is for being assembled to and communicating with an interior of the external device 40, and when the assembling hole 32 is for being liquid sealingly assembled to the external device 40, the filter assembly 30 is for the external device 40 to inlet and filter a fluid.

Please further refer to FIGS. 7 to 9 for an industrial filter 2a of the present invention, including the quick-release device la mentioned above. The industrial filter 2a further includes the filter assembly 30a, the external device 40a includes the shell body 42, the quick-release device 1a is disassembly assembled to the filter assembly 30a, and the quick-release device 1a is disassembly arranged in the shell body 42 so that the filter assembly 30a can be assembled in the shell body 42 via the quick-release assembly 30a. Preferably, the filter assembly 30a can be assembled to other devices (for example, a filter system) via the shell body 42 so that the filter assembly 30a can be further applied to various devices.

Given the above, the quick-release device of the industrial filter can be used on different filters. The quick-release device is reusable and has a simple structure, and the quick-release device can be disassembled quickly so that it is more convenient for a user to replace the filters and conduct visual check. In addition, the filter can be assembled to other equipments and be further applied to other devices.

While we have shown and described various embodiments in accordance with the present invention, it should be clear to those skilled in the art that further embodiments may be made without departing from the scope of the present invention.

What is claimed is:

1. A quick-release device of an industrial filter, including:
a main body, including a first assembling portion and a second assembling portion, the first assembling portion for being non-rotatably and detachably connected with a filter assembly, the second assembling portion for being non-rotatably and detachably assembled to an external device;
a positioning portion, connected to the first assembling portion, the positioning portion for being engaged with a first engaging portion of the filter assembly, the positioning portion including at least one engaging recess or at least one engaging protrusion, the positioning portion being complementary to the first engaging portion in structure.

2. The quick-release device of an industrial filter of claim 1, wherein the first assembling portion includes an opening disposed through the main body, the opening is sleeved around the filter assembly, the opening has a periphery, as viewed along a lateral direction of the periphery, the periphery is curved, and one side thereof is open to form an open side.

3. The quick-release device of an industrial filter of claim 2, wherein the opening is substantially C-shaped, an inner wall of the opening includes the positioning portion, the positioning portion includes at least one protrusive key, the first engaging portion includes at least one recessed portion, and the protrusive key is engageable with the recessed portion.

4. The quick-release device of an industrial filter of claim 2, wherein the opening is substantially Ω-shaped, two opposite sides of the open side of the periphery respectively have a chamfer expanding outwardly.

5. The quick-release device of an industrial filter of claim 4, wherein the positioning portion is arranged neighboring to the open side, the positioning portion includes two abutting portions which are respectively arranged on two opposite ends of the open side, the first engaging portion includes two abutting blocks, and the two abutting portions are for abutting against the two abutting blocks.

6. The quick-release device of an industrial filter of claim 1, wherein the second assembling portion includes two wing portions which are respectively arranged on two opposite external sides of the main body and extend horizontally, the external device includes two grooves opposite to each other, and the two wing portions are for being positionably arranged in the two grooves.

7. The quick-release device of an industrial filter of claim 1, wherein the main body further includes a holding portion, and the holding portion extends outwardly.

8. The quick-release device of an industrial filter of claim 1, wherein the quick-release device is a plastic member which is integrally formed.

9. The quick-release device of an industrial filter of claim 1, wherein the quick-release device is a metal member which is integrally formed.

10. An industrial filter including the quick-release device of claim 1, the industrial filter further including the filter assembly, the filter assembly including at least one assembling hole communicating with an interior of the filter assembly, and the assembling hole for being assembled to and communicating with an interior of the external device.

11. An industrial filter including the quick-release device of claim 1, the industrial filter further including the filter assembly, the external device including a shell body, the quick-release device being positionably arranged in the shell body, and the filter assembly being assembled in the shell body.
